(19) United States
(12) Patent Application Publication
(10) Pub. No.: US 2017/0245192 A1
(43) Pub. Date: Aug. 24, 2017

(54) APPARATUS, SYSTEM AND METHOD OF COMMUNICATING WITH A VEHICLE ALONG A TRANSPORTATION ROUTE

(71) Applicant: INTEL CORPORATION, Santa Clara, CA (US)

(72) Inventors: Ali S. Sadri, San Diego, CA (US); Alexander A. Maltsev, Nizhny Novgorod (RU); Vadim S. Sergeyev, Nizhny Novgorod (RU); Alexey V. Davydov, Nizhny Novgorod (RU)

(21) Appl. No.: 15/500,079

(22) PCT Filed: Aug. 28, 2014
(86) PCT No.: PCT/RU2014/000643

§ 371 Date: Jan. 30, 2017

(51) Int. Cl. H04W 36/38; H04W 4/04; H04W 16/28

(52) U.S. Cl. CPC H04W 36/38; H04W 16/28; H04W 4/046; H04W 88/08

(57) ABSTRACT

Embodiments include devices, systems and/or methods of communicating with a vehicle (102) along a transportation route (104). For example, a system may include a plurality of access points (APs) (120) along the transportation route, an AP of the plurality of APs including a directional antenna (123) to communicate with the vehicle moving along the transportation route via a directional link (127); and at least one AP manager (132) to control handover of the vehicle between the plurality of APs. Communicating with the vehicle may include switching a directional antenna of an AP of the plurality of APs between a plurality of beam settings to steer the directional antenna towards a respective plurality of coverage areas of the transportation route. For example, AP (128) may switch directional antenna (123) between the plurality of beam settings to steer directional antenna (123) towards the respective plurality of coverage areas of transportation route (104). For example, controller (136) may handover vehicle (102) between the plurality of APs (120) according to the order of the plurality of segments (110). Alternatively, controller (136) may handover vehicle (102) from AP (122) to AP (124) based on the quality of communication between AP (122) and vehicle (102). Moreover, controller (136) may handover vehicle (102) from AP (126) to AP (128), when vehicle (102) moves from segment 116 to segment (118).

### TECHNICAL FIELD

Embodiments described herein generally relate to communicating with a vehicle along a transportation route.

### BACKGROUND

The evolution of wireless communication technologies has created demand for increasing amounts of traffic, and strong user expectation to receive broadband connection everywhere, including fast-moving vehicles, e.g., high-speed trains.

However, providing high-speed data connectivity to users in fast-moving vehicles may not be a simple task, for example, when user demand requires support for communicating heavy traffic, such as real-time high definition (HD) video streaming, and the like.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments.

FIG. 2 is a schematic illustration of a deployment of a system along a railroad, in accordance with some demonstrative embodiments.

FIGS. 3A and 3B are a schematic illustrations of a top view and a side view, respectively, of a directional beam coverage for communication between an access point (AP) and a train, in accordance with some demonstrative embodiments.

FIGS. 4A and 4B are a schematic illustrations of a top view and a side view, respectively, of a directional beam coverage for communication between an AP and a train, in accordance with some demonstrative embodiments.

FIG. 5 is a schematic illustration of dual-link communication with a train, in accordance with some demonstrative embodiments.

FIG. 6 is a schematic illustration of a system deployment including wireless backhaul links, in accordance with some demonstrative embodiments.

FIG. 7 is a schematic flow chart illustration of a method of communicating with a vehicle along a transportation route, in accordance with some demonstrative embodiments.

FIG. 8 is a schematic illustration of a product of manufacture, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some embodiments may be used in conjunction with various devices and systems, for example, a vehicle, a high-speed vehicle, a car, a bus, a train, a transportation system, a highway, a railroad, a communication system, a wireless communication system, a wireless node, a wireless access device, a wireless communication station, a wireless communication device, a wireless Access Point (AP), a wired or wireless router, a wired or wireless modem, a wired or wireless network, a wireless area network, a Wireless Video Area Network (WVAN), a Local Area Network (LAN), a Wireless LAN (WLAN), and the like.

Some embodiments may be used in conjunction with devices and/or networks operating in accordance with existing Wireless-Gigabit-Alliance (WGA) specifications (Wireless Gigabit Alliance, Inc WiGig MAC and PHY Specification Version 1.1, April 2011, Final specification) and/or future versions and/or derivatives thereof, devices and/or networks operating in accordance with existing IEEE 802.11 standards (IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, Mar. 29, 2012; IEEE802.11ac-2013 (“IEEE P802.11ac-2013, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 4: Enhancements for Very High Throughput for Operation in Bands below 6 GHz”, December, 2013); IEEE 802.11ad (“IEEE P802.11ad-2012, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band”, 28 Dec. 2012)) and/or future versions and/or derivatives thereof, devices and/or networks operating in accordance with existing Wireless Fidelity (WiFi) Alliance (WFA) Peer-to-Peer (P2P) specifications (WiFi P2P technical specification, version 1.2, 2012) and/or future versions and/or derivatives thereof, devices and/or networks operating in accordance with existing cellular specifications and/or protocols, e.g., 3rd Generation Partnership Project (3GPP), 3GPP Long Term Evolution (LTE) and/or future versions and/or derivatives thereof, units and/or devices which are part of the above networks, and the like.

Some embodiments may be used in conjunction with one way and/or two-way radio communication systems, wireless communication systems, millimeterWave (mmWave) communication systems, wireless access communication systems, transportation systems, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Orthogonal Frequency Division Multiple Access (OFDMA), Spatial Division Multiple Access (SDMA), Multi User MIMO (MU-MIMO), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device.

Some demonstrative embodiments may be used in conjunction with a WLAN. Other embodiments may be used in conjunction with any other suitable wireless communication network, for example, a wireless area network, a “piconet”, a WVAN and the like.

Some demonstrative embodiments may be used in conjunction with a wireless communication network communicating over a frequency band of 60 GHz. However, other embodiments may be implemented utilizing any other suitable wireless communication frequency bands, for example, an Extremely High Frequency (EHF) band (the millimeter wave (mmWave) frequency band), e.g., a frequency band within the frequency band of between 20 Ghz and 300 GHZ, a WLAN frequency band, a frequency band according to the WGA specification, and the like.

The term “antenna”, as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a set of switched beam antennas, and/or the like.

The phrase “access point” (AP), as used herein, may include an entity that contains one station (STA) and provides access to distribution services, via the WM for associated STAs.

The phrases “directional multi-gigabit (DMG)” and “directional band” (DBand), as used herein, may relate to a frequency band wherein the Channel starting frequency is above 56 GHz.

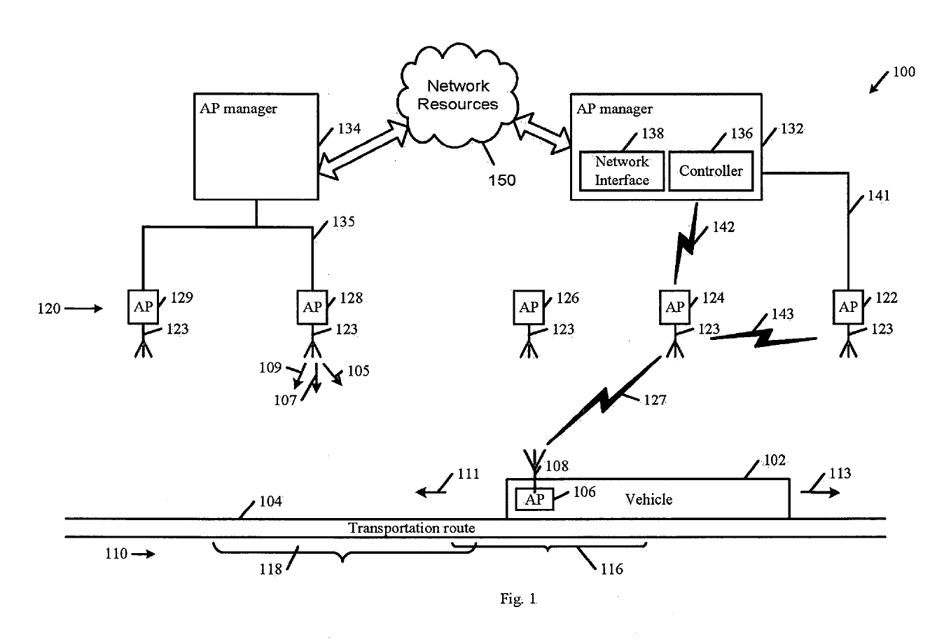

Reference is made to FIG. 1, which schematically illustrates a block diagram of a system 100, in accordance with some demonstrative embodiments.

In some demonstrative embodiments, system 100 may include a transportation route 104 to be used by a vehicle 102.

In some demonstrative embodiments, vehicle 102 may include a train, and transportation route 104 may include a railroad.

In other embodiments, vehicle 102 may include any other vehicle moving along a predefined transportation route. For example, vehicle 102 may include a bus or car, and transportation route 104 may include a highway.

In some demonstrative embodiments, vehicle 102 may include an access point (AP) 106 to provide connectivity to one or more network resources, e.g., the Internet, to a plurality of users traveling within vehicle 102.

In some demonstrative embodiments, vehicle 102 may include, or may be associated with, at least one directional antenna 108.

In some demonstrative embodiments, antenna 108 may be configured to communicate via a directional link.

In some demonstrative embodiments, antenna 108 may include a mmWave antenna, and the directional link may include a mmWave directional link, e.g., a DMG link, for example, to provide high rate data connectivity to the users within vehicle 102

In some demonstrative embodiments, system 100 may be configured to provide high-rate data connectivity to the users within vehicle 102, for example, when vehicle 102 moves along transportation route 104, e.g., at a high speed, e.g., as described below.

In some demonstrative embodiments, system 100 may be configured to continuously provide the data connectivity along transportation route 104, for example, as vehicle 102 moves between different segments of transportation route 104, e.g., as described below.

In some demonstrative embodiments, system 100 may include a plurality of communication nodes, e.g., access points (APs) 120, along transportation route 104. Some embodiments are described herein with respect to communication nodes, e.g., APs 120, configured to provide full AP functionality. However, in other embodiments, one or more of the communication nodes may perform only part of the AP functionality, and/or one or more of the communication nodes may perform other functionalities in addition to the AP functionality.

In some demonstrative embodiments, the plurality of APs 120 may include an AP 122, an AP 124, an AP 126, an AP 128, and/or an AP 129.

In other embodiments, system 100 may include any other number of APs, e.g., ten APs, a hundred APs, a thousand APs, and the like.

In some demonstrative embodiments, the plurality of APs 120 may cover a plurality of segments 110 of transportation route 104.

In some demonstrative embodiments, the plurality of segments 110 may be configured to cover transportation route 104, e.g., continuously or substantially continuously.

In some demonstrative embodiments, a first AP of the plurality of APs 120 may cover a first segment of transportation route 104, and a second AP of the plurality of APs 120 may cover a second segment of transportation route 104. For example, AP 126 may cover a segment 116 of transportation route 104, and AP 128 may cover a segment 118 of transportation route 104.

In some demonstrative embodiments, the second segment may at least partially overlap with the first segment, e.g., to enable continuous coverage of transportation route 104. For example, segment 118 may partially overlap segment 116.

In some demonstrative embodiments, the plurality of APs 120 may be distributed along transportation route 104, for example, to provide an improved and/or optimal coverage area of the APs 120.

In some demonstrative embodiments, at least one AP of APs 120, e.g., only some of APs 120 or each of APs 120, may be configured to provide to the users in vehicle 102 access to one or more network resources 150, e.g., the Internet.

For example, an AP 120 may perform full signal processing, and may provide to the users of vehicle 102 direct access to network resources 150, e.g., via a direct connection between AP 120 and network resources 150.

In some demonstrative embodiments, at least one AP of APs 120, e.g., only some of APs 120 or each of APs 120, may be configured to perform basic signal processing. For example, an AP 120 may be configured to perform frequency conversion and/or beamforming functionalities, while access to network resources 150 may be provided by another element of system 100, e.g., as described below.

In one example, at least one AP 120 may perform the functionality of a remote radio head (RRH), and full processing of the communication between vehicle 102 and network resources 150 may be performed by another entity, e.g., as described below.

In some demonstrative embodiments, an AP 120 may include at least one directional antenna 123 to communicate with vehicle 102 via a directional link.

In one example, AP 124 may communicate with AP 106 via a directional link 127, which may be formed between directional antenna 123 and directional antenna 108.

In some demonstrative embodiments, antennas 108 and/or 123 may include any type of antennas suitable for transmitting and/or receiving wireless communication signals, blocks, frames, transmission streams, packets, messages and/or data. For example, antennas 108 and/or 123 may include any suitable configuration, structure and/or arrangement of one or more antenna elements, components, units, assemblies and/or arrays. Antennas 108 and/or 123 may include, for example, antennas suitable for directional communication, e.g., using beamforming techniques. For example, antennas 108 and/or 123 may include a phased array antenna, a multiple element antenna, a set of switched beam antennas, and/or the like. In some embodiments, antennas 108 and/or 123 may implement transmit and receive functionalities using separate transmit and receive antenna elements. In some embodiments, antennas 108 and/or 123 may implement transmit and receive functionalities using common and/or integrated transmit/receive elements.

In some demonstrative embodiments, directional antennas 108 and/or 123 may include a phased array antenna or a modular array antenna, for example, to enable directional antennas 108 and/or 123 to communicate via more than one directional link, e.g., as described below.

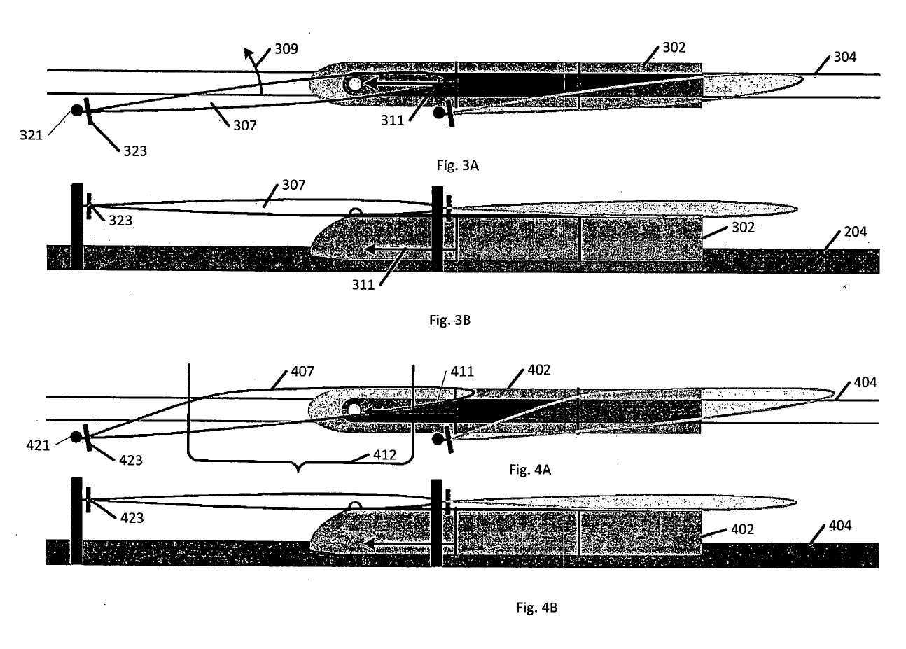

In some demonstrative embodiments, directional antenna 123 may communicate with vehicle 102 via a beam shape, e.g., a cosecant squared beam or any other beam shape, which may be configured, for example, according to an area to be covered by directional antenna 123, a configuration of a segment of route 104 to be covered by directional antenna 123, attributes of directional link 127, and/or any other parameter and/or criterion, e.g., as described below with reference to FIGS. 3A and/or 3B.

In some demonstrative embodiments, an AP 120 may be configured to steer directional antenna 123 in one or more planes, e.g., a horizontal plane and/or a vertical plane, for example, based on a location of vehicle 102 relative to AP 120, e.g., as described below.

In some demonstrative embodiments, an AP 120 may be configured to steer directional antenna 123 to follow movement of vehicle 102 along transportation route 104, e.g., as described below.

In one example, an AP 120 may steer directional antenna 123 in the horizontal plane, for example, to follow movement of vehicle 102 along a planar segment of transportation route 104, e.g., as described below with reference to FIG. 3A.

In another example, an AP 120 may steer directional antenna 123 in the vertical plane, for example, to follow movement of vehicle 102 in a vertical direction, for example, along an inclining or descending segment of transportation route 104, e.g., as described below with reference to FIG. 3B.

In another example, an AP 120 may steer directional antenna 123 in both the vertical plane and the horizontal plane, for example, to follow movement of vehicle 102 in both vertical and horizontal directions with respect to the AP 120.

In some demonstrative embodiments, an AP 120 may switch directional antenna 123 between a plurality of beam settings, for example, according to a beam steering scheme configured to follow the movement of vehicle 102 along transportation route 104, e.g., as described below.

In some demonstrative embodiments, a beam setting of the plurality of beam settings may include a predefined set of phase coefficients to be applied to antenna elements of directional antenna 123 to cover a predefined coverage area.

In some demonstrative embodiments, the plurality of beam settings may be configured to steer directional antenna 123 to a respective plurality of coverage areas of transportation route 104.

For example, AP 128 may steer directional antenna 123 between a first beam setting configured to steer directional antenna 123 to a coverage area 105, a second beam setting configured to steer directional antenna 123 to a coverage area 107, and/or and a third beam setting configured to steer directional antenna 123 to a coverage area 109.

In some demonstrative embodiments, an AP 120 may switch between the plurality of beam settings according to an order of the coverage areas along transportation route 104.

For example, AP 128 may switch the plurality of beam settings from the first beam setting to the second beam setting, and from the second beam setting to the third beam setting.

In some demonstrative embodiments, the AP 120 may switch between the plurality of beam settings according to a direction of movement of vehicle 102 along transportation route 104.

In one example, AP 128 may switch from the first beam setting to the second beam setting, and from the second beam setting to the third beam setting, for example, to follow movement of vehicle 102 along transportation route 104 in a direction 111, e.g., a south direction.

In another example, AP 128 may switch from the third beam setting to the second beam setting, and from the second beam setting to the first beam setting, for example, to follow movement of vehicle 102 along transportation route 104 in a direction 113, e.g., a north direction.

In some demonstrative embodiments, the AP 120 may switch between the plurality of beam settings according to a velocity of vehicle 102.

For example, AP 128 may switch between the first, second and third beam settings at a first rate, for example, when vehicle 102 moves at a first velocity along transportation route 104, and/or AP 128 may switch between the first, second and third beam settings at a second rate, e.g., lesser than the first rate, for example, when vehicle 102 moves at a second velocity, e.g., lesser than the first velocity, along transportation route 104.

In some demonstrative embodiments, an AP 120 may utilize any other suitable methods and/or prediction algorithms to switch between the plurality of beam settings, for example, to follow movement of vehicle 102 along transportation route 104.

In some demonstrative embodiments, system 100 may be configured to provide high-rate data connectivity to vehicle 102 with a high level of efficiency and/or complexity, for example, by avoiding frequent rerouting of communications between vehicle 102 and the plurality of APs 120.

In some demonstrative embodiments, system 100 may include at least one AP manager, e.g., an AP manager 132, to handover vehicle 102 between APs 120, e.g., while maintaining a connection with vehicle 102 during handover between APs managed by AP manager 132.

In some demonstrative embodiments, all APs managed by manager 132 may share the Internet Protocol (IP) address. According to these embodiments, a communication connection between vehicle 102 and network resources 150 may be maintained, e.g., even during handover between the APs controlled by AP manager 132.

In some demonstrative embodiments, the plurality of APs 120 managed by AP manager 132 may perform the functionality of a plurality of antenna sectors of a multi-sector antenna. For example, AP manager 132 may be configured to handover vehicle 102 between two APs in a manner similar to handing over a link between sectors of a multi-sector antenna.

In some demonstrative embodiments, AP manager 132 may be configured to perform, e.g., in a central manner, signal processing of communications communicated via the plurality of APs 120 managed by AP manager 132. According to these embodiments, an AP 120 managed by AP manager 132 may perform a reduced level of signal processing, for example, signal processing corresponding to beam steering of a directional beam between the AP 120 and vehicle 102.

In some demonstrative embodiments, AP manager 132 may be configured to control the handover of vehicle 102 between the plurality of APs 120, e.g., as described below.

In some demonstrative embodiments, AP manager 132 may include a network interface 138 configured to interface between AP manager 132 and the plurality of APs 120.

In some demonstrative embodiments, network interface 138 may include any suitable wireless network interface and/or a wired network interface.

In some demonstrative embodiments, AP manager 132 may communicate with one or more of APs 120 via at least one wired link, e.g., a fiber optic link. For example, AP manager 132 may communicate with AP 122 via a wired link 141.

In some demonstrative embodiments, AP manager 132 may communicate with one or more of APs 120 via at least one wireless link. For example, AP manager 132 may communicate with AP 124 via a wireless link 142.

In some demonstrative embodiments, AP manager 132 may communicate with one or more of APs 120 via at least one wireless backhaul link between two or more APs 120. For example, AP manager 132 may communicate with AP 122 via a wired link 122, and AP manager 132 may communicate with AP 124 via a wireless backhaul link 143 between AP 122 and AP 124, for example, using wireless backhaul link 143 as a relay, e.g., as described below with reference to FIG. 6.

In some demonstrative embodiments, AP manager 132 may communicate with the plurality of APs 120 via any other combination of wired links and wireless links.

In some demonstrative embodiments, AP manager 132 may include a controller 136 configured to control handover of vehicle 102 between the plurality of APs 120, e.g., as described below.

In some demonstrative embodiments, controller 136 may include circuitry configured to perform the functionality of controller 136. Additionally or alternatively, one or more functionalities of controller 136 may be implemented by logic, which may be executed by a machine and/or one or more processors, e.g., as described below.

In some demonstrative embodiments, controller 136 may be configured to control the handover of vehicle 102 between a first AP and a second AP of the plurality of APs 120. For example, controller 136 may be configured to control the handover of vehicle 102 between AP 124 and AP 126.

In some demonstrative embodiments, controller 136 may handover vehicle 102 between the plurality of APs 120 according to an order of the plurality of segments 110 along transportation route 104. For example, controller 136 may handover vehicle 102 from AP 122 to AP 124, and from AP 124 to AP 126.

In some demonstrative embodiments, controller 136 may handover vehicle 102 between the plurality of APs 120 according a direction of movement of vehicle 102 along transportation route 104.

In one example, controller 136 may handover vehicle 102 from AP 122 to AP 124, and from AP 124 to AP 126, for example, to follow a movement of vehicle 102 in direction 111 along transportation route 104.

In another example, controller 136 may handover vehicle 102 from AP 126 to AP 124, and from AP 124 to AP 122, for example, to follow a movement of vehicle 102 in direction 113 along transportation route 104.

In some demonstrative embodiments, controller 136 may handover vehicle 102 between the plurality of APs 120, based on quality measurements of communication between vehicle 102 and one or more of APs 120.

In one example, controller 136 may handover vehicle 102 from AP 122 to AP 124, for example, if a quality of communication between AP 124 and vehicle 102 is greater than a quality of communication between vehicle 102 and other APs of the plurality of APs 120, if a quality of communication between AP 124 and vehicle 102 is greater than a quality threshold, and/or based on any other criterion related to a quality of a link between vehicle 102 and an AP of the plurality of APs120.

In some demonstrative embodiments, controller 136 may handover vehicle 102 from a first AP of the plurality of APs 120 to a second AP of the plurality of APs 120, based on a quality of communication between the first AP and vehicle 102. For example, controller 136 may handover vehicle 102 from AP 122 to AP 124, based on a quality of communication between AP 122 and vehicle 102.

In one example, controller 136 may handover vehicle 102 from AP 122 to AP 124, for example, if the quality of the communication between AP 122 and vehicle 102 is degraded, e.g., below a predefined quality threshold.

In some demonstrative embodiments, controller 136 may handover vehicle 102 between the plurality of APs 120 according to any additional or alternative criteria, algorithm, and/or measurements, e.g., according to a prediction algorithm configured to predict movement of vehicle 102 along route 104, an uplink measurement between vehicle 102 and an AP 120, and/or the like.

In some demonstrative embodiments, system 100 may include more than one AP manager. For example, system 100 may include two AP managers, four AP managers, ten AP mangers, or the like.

In some demonstrative embodiments, system 100 may include at least one AP manager 134, e.g., in addition to AP manager 132.

In some demonstrative embodiments, AP manager 132 may control a first plurality of APs of the plurality of APs 120. For example, AP manager 132 may control AP 122, AP 124 and AP 126.

In some demonstrative embodiments, AP manager 134 may control a second plurality of APs of the plurality of APs 120. For example, AP manager 132 may control AP 128 and AP 129. For example, AP manager 134 may communicate with AP 128 and AP 129 via at least one wired communication link 135.

In other embodiments, AP managers 132 and 134 may control any other APs of the plurality of APs 120.

In some demonstrative embodiments, the first plurality of APs may cover a first plurality of segments of transportation route 104, and the second plurality of APs may cover a second plurality of segments of transportation route 104. For example, the first plurality of APs may cover segment 116 and one or more other segments along transportation route 104, e.g., segments north from segment 116, and/or the second plurality of APs may cover segment 118 and one or more other segments along transportation route 104, e.g., south from segment 118.

In some demonstrative embodiments, AP manager 132 may handover vehicle 102 from an AP of the first plurality of APs to an AP of the second plurality of APs, for example, when vehicle 102 moves from a segment of the first plurality of segments to a segment of the second plurality of segments.

For example, controller 136 may handover vehicle 102 from AP 126 to AP 128, e.g., to follow movement of vehicle 102 from segment 116 to segment 118.

In some demonstrative embodiments, a handover (“hard handover”) between APs belonging to two different AP managers, e.g., handover from an AP controlled by AP manager 132 to an AP controlled by AP manager 134, may be different from a handover (“soft handover”) between two APs sharing the same AP manager, e.g., two APs controlled by AP manager 132. For example, the soft handover may be similar to handing over vehicle 102 between two antenna sectors of a multi-sector antenna, while maintaining connectivity via a shared access node; and the hard handover may be similar to handing over vehicle between two different access nodes.

In some demonstrative embodiments, vehicle 102 may be capable to communicate using more than one directional link, e.g., two directional links.

In one example, antenna 108 may include two directional antennas, e.g., one antenna per each directional link.

In another example, antenna 108 may be capable of generating two directional beams, e.g., one directional beam per each directional link.

In some demonstrative embodiments, system 100 may be configured to provide vehicle 102 with access to network resources 150 via the two directional links, e.g., simultaneously.

In some demonstrative embodiments, first and second APs 120 may be configured to simultaneously communicate with vehicle 102, e.g., via the two directional links.

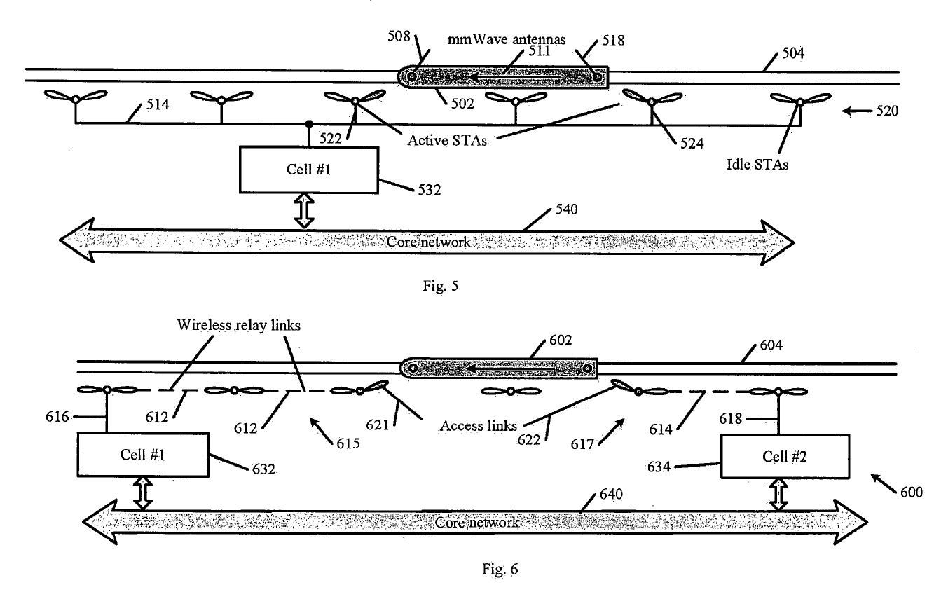

For example, AP 122 and AP 124 may simultaneously provide to vehicle 102 access to network resources 150, for example, via a first directional link between AP 122 and vehicle 102 and a second directional link between AP 124 and vehicle 102, e.g., as described below with reference to FIGS. 5 and/or 6.

In some demonstrative embodiments, the first and second directional links may be formed via two APs sharing the same AP manager, e.g., as described below with reference to FIG. 5.

In some demonstrative embodiments, the first and second directional links may be formed via two APs controlled by two separate AP managers, e.g., as described below with reference to FIG. 6.

In some demonstrative embodiments, communicating with vehicle 102 via two directional links, e.g., via APs 122 and 124, may increase network throughput of the users within vehicle 102.

In some demonstrative embodiments, system 100 may be configured to provide high-rate data connectivity to vehicle 102, for example, while reducing a number of handovers between the plurality of APs 120.

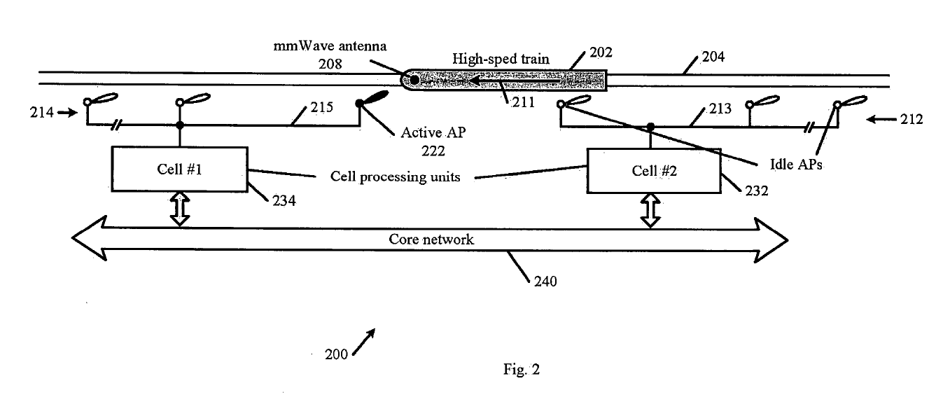

Reference is made to FIG. 2, which schematically illustrates a deployment of a system 200 along a railroad 204, in accordance to some demonstrative embodiments.

As shown in FIG. 2, a train 202 may move along railroad 204. For example, train 202 may perform the functionality of vehicle 102 (FIG. 1), and/or railroad 204 may perform the functionality of transportation route 104 (FIG. 1).

As shown in FIG. 2, train 202 may include a directional antenna 208, e.g., a mmWave antenna, to communicate via a directional link. For example, directional antenna 208 may perform the functionality of directional antenna 108 (FIG. 1).

As shown in FIG. 2, a first plurality of APs 212 may be connected via wired links 213 to a first AP manager (also referred to as “cell processing unit”) 232, and/or a second plurality of APs 214 may be connected via wired links 215 to a second AP manager 234. For example, AP manager 232 and/or 234 may perform the functionality of AP managers 132 and/or 134 (FIG. 1).

As shown in FIG. 2, AP managers 232 and 234 may be connected to a core network 240 to provide train 202 with access to one or more network resources.

As shown in FIG. 2, AP manager 234 may communicate with train 202 via an AP (“active AP”) 222, which may cover an area including train 202, e.g., while other APs of the plurality of APs 212 and 214 may be idle.

In some demonstrative embodiments, a distance covered by an AP of APs 212 and/or 214 may depend on an antenna gain of an antenna of the AP and on an antenna gain of antenna 208.

In one example, APs 212 and/or 214 may be configured to cover a distance along railroad 204 of between two and four kilometers (km), for example, if communicating via a 60 GHz band, and using a gain of at least 51 decibel isotropic (dBi). Greater distances may be covered by the AP, for example, if communicating via other mmWave bands, e.g., a 28 GHz mmWave band, a 38 GHz 28 GHz mmWave band, a 71-76 28 GHz mmWave band, a 81-86 GHz 28 GHz mmWave band, and/or any other suitable mmWave frequency band; and/or using increased gains, e.g., a gain greater than 51 dBi.

In some demonstrative embodiments, an AP manager of AP managers 232 and/or 234 may manage a large number of APs, e.g., one hundred APs, which may enable the AP manager to cover a relatively large distance along railroad 204, e.g., a distance of several hundred kilometers.

In some demonstrative embodiments, configuring AP managers 232 and/or 234 to cover a large distance along railroad 204, may enable using a reduced number of AP managers, and, accordingly, may reduce a number of hard handovers of train 202.

In some demonstrative embodiments, AP managers 232 and 234 may determine an active AP to communicate with train 202, e.g., when train 202 moves along railroad 204, for example, based on uplink measurements from train 202, and/or any other measurements between the plurality of APs 212 and train 202, e.g., as described above.

Reference is made to FIGS. 3A and 3B, which schematically illustrate a top view and a side view, respectively, of a directional beam coverage for communication between an AP 321 and a train 302 along a railroad 304, in accordance with some demonstrative embodiments. For example, AP 321 may perform the functionality of AP 120 (FIG. 1), train 302 may perform the functionality of vehicle 102 (FIG. 1), and/or railroad 304 may perform the functionality of transportation route 104 (FIG. 1).

As shown in FIGS. 3A and 3B, a directional antenna 323 of AP 321 may be mounted on a pole, e.g., adjacent to railroad 304, and may form a directional beam 307. For example, directional antenna 323 may perform the functionality of directional antenna 123 (FIG. 1).

As shown in FIGS. 3A and 3B, directional beam 307 may include a relatively narrow beam, e.g., a pencil-shaped beam, for example, to enable directional antenna 323 to cover a long distance along railroad 304, e.g., a distance between 2-4 km, or any other distance.

As shown in FIG. 3A, AP 321 may steer directional beam 307 in a horizontal plane at a counterclockwise direction 309, for example, to maintain a directional link with train 302, e.g., when train 302 is moving along railroad 304.

As shown in FIG. 3B, AP 321 may not steer directional beam 307 in a vertical plane, for example, if railroad 304 is substantially planar within the coverage area of beam 307.

In some demonstrative embodiments, AP 321 may steer directional antenna 323 in both the horizontal and vertical planes, for example, if there are changes in an altitude of railroad 304 within the coverage area of beam 307.

In some demonstrative embodiments, AP 321 may steer directional antenna 323 by switching between a plurality of predefined beam settings. In one example, the beam settings may be configured such that each switch between the predefined beam settings may result in a slight move of directional beam 307 in counterclockwise direction 309.

In some demonstrative embodiments, the AP may implement a predefined beam shape, which may be configured to have a coverage area, which may enable to reduce a number of switches between the predefined beam settings, e.g., as described below with reference to FIGS. 4A and 4B.

Reference is made to FIGS. 4A and 4B, which schematically illustrate a top view and a side view, respectively, of a directional beam coverage for communication between an AP 421 and a train 402 along a railroad 404, in accordance with some demonstrative embodiments. For example, train 402 may perform the functionality of vehicle 102 (FIG. 1), AP 421 may perform the functionality of AP 120 (FIG. 1), and/or railroad 404 may perform the functionality of railroad 104 (FIG. 1).

As shown in FIGS. 4A and 4B, train 402 may move in a direction 411 along railroad 404.

As shown in FIGS. 4A and 4B, AP 421 may have a directional antenna 423, which may be mounted on a pole, e.g., adjacent to railroad 404, and may generate a directional beam 407. For example, directional antenna 423 may perform the functionality of directional antenna 123 (FIG. 1).

As shown in FIG. 4A, directional beam 407 may be configured to have a squared cosecant beam shape. The squared cosecant beam shape may cover a long distance in a horizontal plane along railroad 404. Accordingly, directional beam 407 may be able to maintain a directional link with train 402 for a relatively long time, for example, without switching between beam settings of antenna 423, e.g., to steer directional antenna 423 in the horizontal plane.

As shown in FIG. 4A, AP 421 may not be required to steer directional antenna 423, for example, as long as train 402 moves along segment 412 of railroad 404, e.g., due to the increased coverage of the squared cosecant beam shape.

As shown in FIG. 4B, AP 421 may not be required to steer directional antenna 423 in the vertical plane, for example, as long as an altitude of train 402 does not change significantly.

Reference is made to FIG. 5, which schematically illustrates dual-link communication with a train 502, in accordance with some demonstrative embodiments. For example, train 502 may perform the functionality of vehicle 102 (FIG. 1).

As shown in FIG. 5, train 502 may move in a direction 511 along a railroad 504. For example, railroad 504 may perform the functionality of transportation route 104 (FIG. 1).

As shown in FIG. 5, train 502 may include two directional antennas, e.g., a directional antenna 508 and a directional antenna 518, to communicate via two respective directional links. For example, directional antennas 508 and/or 518 may perform the functionality of directional antenna 108 (FIG. 1).

As shown in FIG. 5, a plurality of APs 520 may be connected via wired links 514 to an AP manager 532. For example, AP manager 532 may perform the functionality of AP manager 132 (FIG. 1), and/or the plurality of APs 520 may perform the functionality of the plurality of APs 120 (FIG. 1).

As shown in FIG. 5, AP manager 532 may be connected to a core network 540 to provide train 502 with access to one or more network resources.

As shown in FIG. 5, AP manager 532 may communicate with train 502 via two directional links.

For example, AP manager 532 may communicate with train 502 via a first link through AP 522, e.g., via directional antenna 508, and a second link through AP 524, e.g., via directional antenna 518.

In some demonstrative embodiments, using the two directional links to communicate with train 502 may increase a data rate for communicating data between train 502 and the core network.

In some demonstrative embodiments, directional antennas 508 and/or 518 may be steerable, for example, to enable train 502 to establish the two directional links, e.g., to AP 522 and AP 524, and to suppress interference from other APs of APS 520 and/or other sources of interferences.

Reference is made to FIG. 6, which schematically illustrates a system deployment 600 including wireless backhaul links, in accordance with some demonstrative embodiments.

As shown in FIG. 6, a train 602 may move in a direction 611 along a railroad 604. For example, train 602 may perform the functionality of vehicle 102 (FIG. 1), and/or railroad 604 may perform the functionality of transportation route 104 (FIG. 1).

As shown in FIG. 6, train 602 may include two directional antennas, e.g., a directional antenna 608 and a directional antenna 618, to communicate via two respective directional links. For example, directional antennas 608 and/or 618 may perform the functionality of directional antenna 108 (FIG. 1).

As shown in FIG. 6, a first plurality of APs 615 may be connected via at least one wired link 616 and a plurality of wireless backhaul links 612 to a first AP manager 632; and a second plurality of APs 617 may be connected via at least one wired link 618 and a plurality of wireless backhaul links 614 to a second AP manager 634. For example, AP manager 632 and/or 634 may perform the functionality of AP managers 132 and/or 134 (FIG. 1).

In other embodiments, the first plurality of APs 615 may be connected to the first AP manager 632 using the plurality of wireless backhaul links 612, e.g., without using wired link 616; and/or the second plurality of APs 617 may be connected to the second AP manager 634 using the plurality of wireless backhaul links 614, e.g., without using wired link 618.

As shown in FIG. 6, AP managers 632 and/or 634 may be connected to a core network 640.

As shown in FIG. 6, train 602 may communicate via a first directional link 621 and a second directional link 622, e.g., to access core network 640

As shown in FIG. 6, the first plurality of backhaul links 615 may be used as relays between one or more APs 615, and wired link 616 and/or AP manager 632.

As shown in FIG. 6, the second plurality of backhaul links 614 may be used as relays between one or more APs 617, and wired link 618 and/or AP manager 632.

In some demonstrative embodiments, a number of the first plurality of backhaul links 612 and the second plurality of backhaul links 614 may dynamically change, for example, based on movement of train 602 along railroad 604.

In some demonstrative embodiments, using both directional links 621 and 622 to communicate with train 602 may increase data rate provided to and/or delivered from train 602, e.g., proportionally to the number of directional links.

In some demonstrative embodiments, wireless backhaul links 615 and/or 617 may include mmWave links.

In some demonstrative embodiments, an antenna of an AP of the plurality of APs 615 or 617 may be configured to communicate over both backhaul links 612 or 614 and directional link 622 or 621. In other embodiments, separate antennas may be used for the backhaul and directional links.

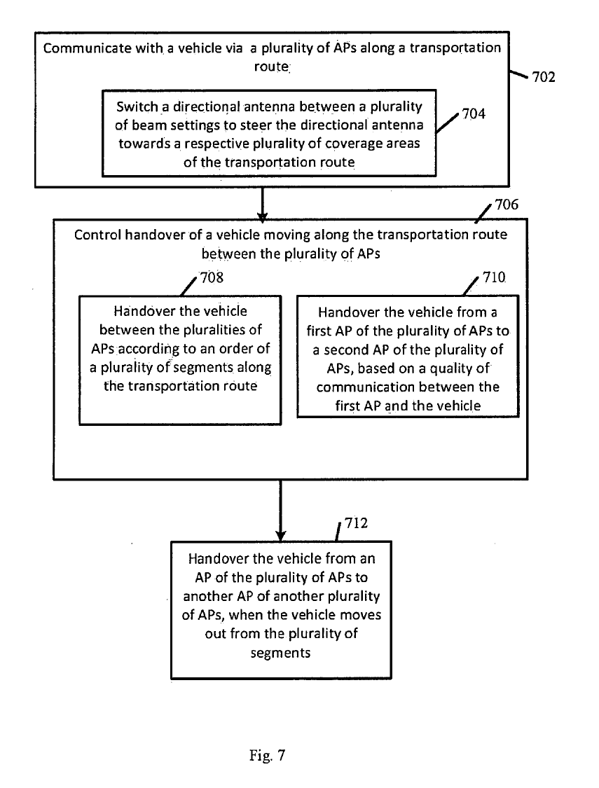

Reference is made to FIG. 7, which schematically illustrates a method of communicating with a vehicle along a transportation route, in accordance with some demonstrative embodiments. In some embodiments, one or more of the operations of the method of FIG. 7 may be performed by a system, e.g., system 100 (FIG. 1), an AP manager, e.g., AP managers 132 and/or 134 (FIG. 1), AP managers 232 and/or 234 (FIG. 2), AP manager 532 (FIG. 5), and/or AP managers 632 and/or 634 (FIG. 6), an AP, e.g., AP 120 (FIG. 1), AP 222 and/or AP 224 (FIG. 2), AP 520 (FIG. 5), AP 620 (FIG. 6), a controller, e.g., controller 136 (FIG. 1), and/or a network interface, e.g., network interface 138 (FIG. 1).

As indicated at block 702, the method may include communicating with a vehicle along a transportation route via directional links formed by a plurality of APs along the transportation route. For example, AP manager 132 (FIG. 1) may communicate with vehicle 102 (FIG. 1) via the plurality of APs 120 (FIG. 1), e.g., as described above.

As indicated at block 704, communicating with the vehicle may include switching a directional antenna of an AP of the plurality of APs between a plurality of beam settings to steer the directional antenna towards a respective plurality of coverage areas of the transportation route. For example, AP 128 (FIG. 1) may switch directional antenna 123 (FIG. 1) between the plurality of beam settings to steer directional antenna 123 (FIG. 1) towards the respective plurality of coverage areas of transportation route 104 (FIG. 1), e.g., as described above.

As indicated at block 706, the method may include controlling handover of the vehicle between the plurality of APs. For example, controller 136 (FIG. 1) may control handover of vehicle 102 (FIG. 1) between the plurality of APs 120 (FIG. 1), e.g., as described above.

As indicated at block 708, controlling the handover of the vehicle may include handing over the vehicle between the pluralities of APs according to an order of a plurality of segments along the transportation route. For example, controller 136 (FIG. 1) may handover vehicle 102 (FIG. 1) between the plurality of APs 120 (FIG. 1) according to the order of the plurality of segments 110 (FIG. 1), e.g., as described above.

As indicated at block 710, controlling the handover of the vehicle may include handing over the vehicle from a first AP of the plurality of APs to a second AP of the plurality of APs, based on a quality of communication between the first AP and the vehicle. For example, controller 136 (FIG. 1) may handover vehicle 102 (FIG. 1) from AP 122 (FIG. 1) to AP 124 (FIG. 1) based on the quality of communication between AP 122 (FIG. 1) and vehicle 102 (FIG. 1), e.g., as described above.

As indicated at block 712, the method may include handing over the vehicle from an AP of the plurality of APs to another AP of another plurality of APs, when the vehicle moves out from the plurality of segments. For example, controller 136 (FIG. 1) may handover vehicle 102 (FIG. 1) from AP 126 (FIG. 1) to AP 128 (FIG. 1), when vehicle 102 moves from segment 116 (FIG. 1) to segment 118 (FIG. 1), e.g., as described above.

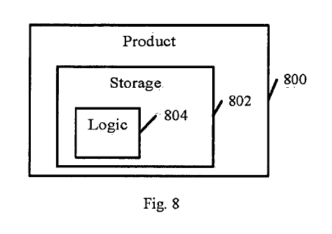

Reference is made to FIG. 8, which schematically illustrates a product of manufacture 800, in accordance with some demonstrative embodiments. Product 800 may include a non-transitory machine-readable storage medium 802 to store logic 804, which may be used, for example, to perform at least part of the functionality of system 100 (FIG. 1), AP managers 132 and/or 134 (FIG. 1), AP managers 232 and/or 234 (FIG. 2), AP manager 532 (FIG. 5), AP managers 632 and/or 634 (FIG. 6), APs 120 (FIG. 1), AP 122 and/or 124 (FIG. 1), AP 520 (FIG. 5), AP 620 (FIG. 6), controller 136 (FIG. 1), network interface 138 (FIG. 1), and/or to perform one or more operations of the method of FIG. 7. The phrase “non-transitory machine-readable medium” is directed to include all computer-readable media, with the sole exception being a transitory propagating signal.

In some demonstrative embodiments, product 800 and/or machine-readable storage medium 802 may include one or more types of computer-readable storage media capable of storing data, including volatile memory, non-volatile memory, removable or non-removable memory, erasable or non-erasable memory, writeable or re-writeable memory, and the like. For example, machine-readable storage medium 802 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 804 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 804 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

### EXAMPLES

The following examples pertain to further embodiments.

Example 1 includes a system comprising a plurality of access points (APs) along a transportation route, an AP of the plurality of APs including a directional antenna to communicate with a vehicle moving along the transportation route via a directional link; and at least one AP manager to control handover of the vehicle between the plurality of APs.

Example 2 includes the subject matter of Example 1, and optionally, wherein the plurality of APs cover a plurality of segments of the transportation route, and wherein the AP manager is to handover the vehicle between the plurality of APs according to an order of the plurality of segments along the transportation route.

Example 3 includes the subject matter of Example 2, and optionally, wherein the plurality of segments continuously covers the transportation route.

Example 4 includes the subject matter of any one of Examples 1-3, and optionally, wherein the AP manager is to handover the vehicle between the plurality of APs according to a direction of movement of the vehicle along the transportation route.

Example 5 includes the subject matter of any one of Examples 1-4, and optionally, wherein the AP manager is to handover the vehicle from a first AP of the plurality of APs to a second AP of the plurality of APs, based on a quality of communication between the vehicle and at least one AP of the plurality of APs.

Example 6 includes the subject matter of any one of Examples 1-5, and optionally, wherein the AP is to switch the directional antenna between a plurality of beam settings to steer the directional antenna towards a respective plurality of coverage areas of the transportation route.

Example 7 includes the subject matter of Example 6, and optionally, wherein the AP is to switch between the plurality of beam settings according to an order of the coverage areas along the transportation route.

Example 8 includes the subject matter of Example 6 or 7, and optionally, wherein the AP is to switch between the plurality of beam settings according to a velocity of the vehicle.

Example 9 includes the subject matter of any one of Examples 1-8, and optionally, wherein the AP is configured to steer the directional antenna in at least one plane selected from the group consisting of a horizontal plane and a vertical plane, based on a location of the vehicle relative to the AP.

Example 10 includes the subject matter of any one of Examples 1-9, and optionally, wherein a first AP of the plurality of APs is to cover a first segment of the transportation route, and a second AP of the plurality of APs is to cover a second segment of the route, the second segment partially overlapping the first segment.

Example 11 includes the subject matter of any one of Examples 1-10, and optionally, comprising at least a first AP manager and a second AP manger, the first AP manager to control a first plurality of APs of the plurality of APs, and the second AP manager to control a second plurality of APs of the plurality of APs, wherein the first plurality of APs cover a first plurality of segments of the transportation route, and the second plurality of APs cover a second plurality of segments of the transportation route.

Example 12 includes the subject matter of Example 11, and optionally, wherein the first AP manager is to handover the vehicle from an AP of the first plurality of APs to an AP of the second plurality of APs, when the vehicle moves from a segment of the first plurality of segments to a segment of the second plurality of segments.

Example 13 includes the subject matter of Example 11 or 12, and optionally, wherein the first AP manager and the second AP manager are to simultaneously provide to the vehicle access to one or more network resources.

Example 14 includes the subject matter of any one of Examples 1-13, and optionally, wherein the AP is to provide to the vehicle access to one or more network resources.

Example 15 includes the subject matter of any one of Examples 1-14, and optionally, wherein the AP manager is to communicate with the plurality of APs via at least one wired link.

Example 16 includes the subject matter of any one of Examples 1-15, and optionally, wherein the AP manager is to communicate with the plurality of APs via at least one wireless backhaul link.

Example 17 includes the subject matter of Example 16, and optionally, wherein the AP manager is to communicate with a first AP of the plurality of APs via a wireless backhaul link between the first AP and a second AP of the plurality of APs.

Example 18 includes the subject matter of any one of Examples 1-17, and optionally, wherein the vehicle includes a train, and the transportation route includes a railroad.

Example 19 includes the subject matter of any one of Examples 1-18, and optionally, wherein the directional antenna comprises a phased array antenna or a modular array antenna.

Example 20 includes the subject matter of any one of Examples 1-19, and optionally, wherein the directional antenna is to communicate with the vehicle via a cosecant squared beam.

Example 21 includes the subject matter of any one of Examples 1-20, and optionally, wherein the directional link comprises a millimeter wave (mmWave) directional link.

Example 22 includes an access point (AP) manager comprising a network interface to interface between the AP manager and a plurality of access points (APs) along a transportation route; and a controller to control handover of a vehicle moving along the transportation route between the plurality of APs.

Example 23 includes the subject matter of Example 22, and optionally, wherein the plurality of APs cover a plurality of segments of the transportation route, and wherein the controller is to handover the vehicle between the plurality of APs according to an order of the plurality of segments along the transportation route.

Example 24 includes the subject matter of Example 22 or 23, and optionally, wherein the controller is to handover the vehicle between the plurality of APs according to a direction of movement of the vehicle along the transportation route.

Example 25 includes the subject matter of any one of Examples 22-24, and optionally, wherein the controller is to handover the vehicle from a first AP of the plurality of APs to a second AP of the plurality of APs, based on a quality of communication between the vehicle and at least one AP of the plurality of APs.

Example 26 includes the subject matter of Example 22-25, and optionally, wherein the controller is to handover the vehicle from a first AP of the plurality of APs to a second AP of another plurality of APs controlled by another AP manager.

Example 27 includes the subject matter of Example 26, and optionally, wherein the AP manager and the another AP manager are to simultaneously provide to the vehicle access to one or more network resources.

Example 28 includes the subject matter of any one of Examples 22-27, and optionally, wherein the network interface is to communicate with the plurality of APs via at least one wired link.

Example 29 includes the subject matter of any one of Examples 22-28, and optionally, wherein the network interface is to communicate with the plurality of APs via at least one wireless backhaul link.

Example 30 includes the subject matter of Example 29, and optionally, wherein the network interface is to communicate with a first AP of the plurality of APs via a wireless backhaul link between the first AP and a second AP of the plurality of APs.

Example 31 includes the subject matter of any one of Examples 22-30, and optionally, wherein the vehicle includes a train, and the transportation route includes a railroad.

Example 32 includes a method comprising communicating with a vehicle along a transportation route via directional links formed by a plurality of Access Points (APs) along the transportation route; and controlling handover of the vehicle between the plurality of APs.

Example 33 includes the subject matter of Example 32, and optionally, wherein the plurality of APs cover a plurality of segments of the transportation route, and wherein controlling the handover comprises handing over the vehicle between the plurality of APs according to an order of the plurality of segments along the transportation route.

Example 34 includes the subject matter of Example 32 or 33, and optionally, comprising handing over the vehicle between the plurality of APs according to a direction of movement of the vehicle along the transportation route.

Example 35 includes the subject matter of any one of Examples 32-34, and optionally, comprising handing over the vehicle from a first AP of the plurality of APs to a second AP of the plurality of APs, based on a quality of communication between the vehicle and at least one AP of the plurality of APs.

Example 36 includes the subject matter of any one of Examples 32-35, and optionally, comprising switching a directional antenna of an AP of the plurality of APs between a plurality of beam settings to steer the directional antenna towards a respective plurality of coverage areas of the transportation route.

Example 37 includes the subject matter of Example 36, and optionally, comprising switching between the plurality of beam settings according to an order of the coverage areas along the transportation route.

Example 38 includes the subject matter of Example 36 or 37, and optionally, comprising switching between the plurality of beam settings according to a velocity of the vehicle.

Example 39 includes the subject matter of any one of Examples 32-38, and optionally, comprising steering a directional antenna of an AP of the plurality of APs in at least one plane selected from the group consisting of a horizontal plane and a vertical plane, based on a location of the vehicle relative to the AP.

Example 40 includes the subject matter of any one of Examples 32-39, and optionally, comprising handing over the vehicle from the plurality of APs to another plurality of APs, when the vehicle moves out from a coverage area of the plurality of APs.

Example 41 includes the subject matter of any one of Examples 32-40, and optionally, comprising communicating with the plurality of APs via at least one wired link.

Example 42 includes the subject matter of any one of Examples 32-41, and optionally, comprising communicating with the plurality of APs via at least one wireless backhaul link.

Example 43 includes the subject matter of Example 42, and optionally, comprising communicating with a first AP of the plurality of APs via a wireless backhaul link between the first AP and a second AP of the plurality of APs.

Example 44 includes the subject matter of any one of Examples 32-43, and optionally, wherein the vehicle includes a train, and the transportation route includes a railroad.

Example 45 includes a product including one or more tangible computer-readable non-transitory storage media comprising computer-executable instructions operable to, when executed by at least one computer processor, enable the at least one computer processor to implement a method comprising communicating with a vehicle along a transportation route via directional links formed by a plurality of Access Points (APs) along the transportation route; and controlling handover of the vehicle between the plurality of APs.

Example 46 includes the subject matter of Example 45, and optionally, wherein the plurality of APs cover a plurality of segments of the transportation route, and wherein controlling the handover comprises handing over the vehicle between the plurality of APs according to an order of the plurality of segments along the transportation route.

Example 47 includes the subject matter of Example 45 or 46, and optionally, wherein the method comprises handing over the vehicle between the plurality of APs according to a direction of movement of the vehicle along the transportation route.

Example 48 includes the subject matter of any one of Examples 45-47, and optionally, wherein the method comprises handing over the vehicle from a first AP of the plurality of APs to a second AP of the plurality of APs, based on a quality of communication between the vehicle and at least one AP of the plurality of APs.

Example 49 includes the subject matter of any one of Examples 45-48, and optionally, wherein the method comprises switching a directional antenna of an AP of the plurality of APs between a plurality of beam settings to steer the directional antenna towards a respective plurality of coverage areas of the transportation route.

Example 50 includes the subject matter of Example 49, and optionally, wherein the method comprises switching between the plurality of beam settings according to an order of the coverage areas along the transportation route.

Example 51 includes the subject matter of Example 49 or 50, and optionally, wherein the method comprises switching between the plurality of beam settings according to a velocity of the vehicle.

Example 52 includes the subject matter of any one of Examples 45-51, and optionally, wherein the method comprises steering a directional antenna of an AP of the plurality of APs in at least one plane selected from the group consisting of a horizontal plane and a vertical plane, based on a location of the vehicle relative to the AP.

Example 53 includes the subject matter of any one of Examples 45-52, and optionally, wherein the method comprises handing over the vehicle from the plurality of APs to another plurality of APs, when the vehicle moves out from a coverage area of the plurality of APs.

Example 54 includes the subject matter of any one of Examples 45-53, and optionally, wherein the method comprises communicating with the plurality of APs via at least one wired link.

Example 55 includes the subject matter of any one of Examples 45-54, and optionally, wherein the method comprises communicating with the plurality of APs via at least one wireless backhaul link.

Example 56 includes the subject matter of Example 55, and optionally, wherein the method comprises communicating with a first AP of the plurality of APs via a wireless backhaul link between the first AP and a second AP of the plurality of APs.

Example 57 includes the subject matter of any one of Examples 45-56, and optionally, wherein the vehicle includes a train, and the transportation route includes a railroad.

Example 58 includes an apparatus comprising means for communicating with a vehicle along a transportation route via directional links formed by a plurality of Access Points (APs) along the transportation route; and means for controlling handover of the vehicle between the plurality of APs.

Example 59 includes the subject matter of Example 58, and optionally, wherein the plurality of APs cover a plurality of segments of the transportation route, and wherein controlling the handover comprises handing over the vehicle between the plurality of APs according to an order of the plurality of segments along the transportation route.

Example 60 includes the subject matter of Example 58 or 59, and optionally, comprising means for handing over the vehicle between the plurality of APs according to a direction of movement of the vehicle along the transportation route.

Example 61 includes the subject matter of any one of Examples 58-60, and optionally, comprising means for handing over the vehicle from a first AP of the plurality of APs to a second AP of the plurality of APs, based on a quality of communication between the vehicle and at least one AP of the plurality of APs.

Example 62 includes the subject matter of any one of Examples 58-61, and optionally, comprising means for switching a directional antenna of an AP of the plurality of APs between a plurality of beam settings to steer the directional antenna towards a respective plurality of coverage areas of the transportation route.

Example 63 includes the subject matter of Example 62, and optionally, comprising means for switching between the plurality of beam settings according to an order of the coverage areas along the transportation route.

Example 64 includes the subject matter of Example 62 or 63, and optionally, comprising means for switching between the plurality of beam settings according to a velocity of the vehicle.

Example 65 includes the subject matter of any one of Examples 58-64, and optionally, comprising means for steering a directional antenna of an AP of the plurality of APs in at least one plane selected from the group consisting of a horizontal plane and a vertical plane, based on a location of the vehicle relative to the AP.

Example 66 includes the subject matter of any one of Examples 58-65, and optionally, comprising means for handing over the vehicle from the plurality of APs to another plurality of APs, when the vehicle moves out from a coverage area of the plurality of APs.

Example 67 includes the subject matter of any one of Examples 58-66, and optionally, comprising means for communicating with the plurality of APs via at least one wired link.

Example 68 includes the subject matter of any one of Examples 58-67, and optionally, comprising means for communicating with the plurality of APs via at least one wireless backhaul link.

Example 69 includes the subject matter of Example 68, and optionally, comprising means for communicating with a first AP of the plurality of APs via a wireless backhaul link between the first AP and a second AP of the plurality of APs.

Example 70 includes the subject matter of any one of Examples 58-70, and optionally, wherein the vehicle includes a train, and the transportation route includes a railroad.

Example 71 includes a method comprising communicating between an AP manager and a plurality of access points (APs) along a transportation route; and controlling handover of a vehicle moving along the transportation route between the plurality of APs.

Example 72 includes the subject matter of Example 71, and optionally, wherein the plurality of APs cover a plurality of segments of the transportation route, the method comprising handing over the vehicle between the plurality of APs according to an order of the plurality of segments along the transportation route.

Example 73 includes the subject matter of Example 71 or 72, and optionally, comprising handing over the vehicle between the plurality of APs according to a direction of movement of the vehicle along the transportation route.

Example 74 includes the subject matter of any one of Examples 71-73, and optionally, comprising handing over the vehicle from a first AP of the plurality of APs to a second AP of the plurality of APs, based on a quality of communication between the vehicle and at least one AP of the plurality of APs.

Example 75 includes the subject matter of any one of Examples 71-74, and optionally, comprising handing over the vehicle from a first AP of the plurality of APs to a second AP of another plurality of APs controlled by another AP manager.

Example 76 includes the subject matter of Example 75, and optionally, comprising simultaneously providing to the vehicle access to network resources via the first and second APs.

Example 77 includes the subject matter of any one of Examples 71-76, and optionally, comprising communicating with the plurality of APs via at least one wired link.

Example 78 includes the subject matter of any one of Examples 71-77, and optionally, comprising communicating with the plurality of APs via at least one wireless backhaul link.

Example 79 includes the subject matter of Example 78, and optionally, comprising communicating with a first AP of the plurality of APs via a wireless backhaul link between the first AP and a second AP of the plurality of APs.

Example 80 includes the subject matter of any one of Examples 71-79, and optionally, wherein the vehicle includes a train, and the transportation route includes a railroad.

Example 81 includes a product including one or more tangible computer-readable non-transitory storage media comprising computer-executable instructions operable to, when executed by at least one computer processor, enable the at least one computer processor to implement a method comprising communicating with a vehicle along a transportation route via directional links formed by a plurality of Access Points (APs) along the transportation route; and controlling handover of the vehicle between the plurality of APs.

Example 82 includes the subject matter of Example 81, and optionally, wherein the plurality of APs cover a plurality of segments of the transportation route, the method comprising handing over the vehicle between the plurality of APs according to an order of the plurality of segments along the transportation route.

Example 83 includes the subject matter of Example 81 or 82, and optionally, wherein the method comprises handing over the vehicle between the plurality of APs according to a direction of movement of the vehicle along the transportation route.

Example 84 includes the subject matter of any one of Examples 81-83, and optionally, wherein the method comprises handing over the vehicle from a first AP of the plurality of APs to a second AP of the plurality of APs, based on a quality of communication between the vehicle and at least one AP of the plurality of APs.

Example 85 includes the subject matter of any one of Examples 81-84, and optionally, wherein the method comprises handing over the vehicle from a first AP of the plurality of APs to a second AP of another plurality of APs controlled by another AP manager.

Example 86 includes the subject matter of Example 85, and optionally, wherein the method comprises simultaneously providing to the vehicle access to network resources via the first and second APs.

Example 87 includes the subject matter of any one of Examples 81-86, and optionally, wherein the method comprises communicating with the plurality of APs via at least one wired link.

Example 88 includes the subject matter of any one of Examples 81-87, and optionally, wherein the method comprises communicating with the plurality of APs via at least one wireless backhaul link.

Example 89 includes the subject matter of Example 88, and optionally, wherein the method comprises communicating with a first AP of the plurality of APs via a wireless backhaul link between the first AP and a second AP of the plurality of APs.

Example 90 includes the subject matter of any one of Examples 81-89, and optionally, wherein the vehicle includes a train, and the transportation route includes a railroad.

Example 91 includes an apparatus comprising means for communicating between an AP manager and a plurality of access points (APs) along a transportation route; and means for controlling handover of a vehicle moving along the transportation route between the plurality of APs.

Example 92 includes the subject matter of Example 91, and optionally, wherein the plurality of APs cover a plurality of segments of the transportation route, the controlling comprising handing over the vehicle between the plurality of APs according to an order of the plurality of segments along the transportation route.

Example 93 includes the subject matter of Example 91 or 92, and optionally, comprising means for handing over the vehicle between the plurality of APs according to a direction of movement of the vehicle along the transportation route.

Example 94 includes the subject matter of any one of Examples 91-93, and optionally, comprising means for handing over the vehicle from a first AP of the plurality of APs to a second AP of the plurality of APs, based on a quality of communication between the vehicle and at least one AP of the plurality of APs.

Example 95 includes the subject matter of any one of Examples 91-94, and optionally, comprising means for handing over the vehicle from a first AP of the plurality of APs to a second AP of another plurality of APs controlled by another AP manager.

Example 96 includes the subject matter of Example 95, and optionally, comprising means for simultaneously providing to the vehicle access to network resources via the first and second APs.

Example 97 includes the subject matter of any one of Examples 91-96, and optionally, comprising means for communicating with the plurality of APs via at least one wired link.

Example 98 includes the subject matter of any one of Examples 91-97, and optionally, comprising means for communicating with the plurality of APs via at least one wireless backhaul link.

Example 99 includes the subject matter of Example 98, and optionally, comprising means for communicating with a first AP of the plurality of APs via a wireless backhaul link between the first AP and a second AP of the plurality of APs.

Example 100 includes the subject matter of any one of Examples 91-99, and optionally, wherein the vehicle includes a train, and the transportation route includes a railroad.

Functions, operations, components and/or features described herein with reference to one or more embodiments, may be combined with, or may be utilized in combination with, one or more other functions, operations, components and/or features described herein with reference to one or more other embodiments, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the invention.

1.-25. (canceled)

26. A system comprising:
a plurality of access points (APs) along a transportation route, an AP of said plurality of APs including a directional antenna to communicate with a vehicle moving along said transportation route via a directional link; and
at least one AP manager to control handover of said vehicle between said plurality of APs.

27. The system of claim 26, wherein said plurality of APs cover a plurality of segments of said transportation route, and wherein said AP manager is to handover said vehicle between said plurality of APs according to an order of said plurality of segments along said transportation route.

28. The system of claim 27, wherein said plurality of segments continuously covers said transportation route.

29. The system of claim 26, wherein said AP manager is to handover said vehicle between said plurality of APs according to a direction of movement of said vehicle along said transportation route.

30. The system of claim 26, wherein said AP is to switch said directional antenna between a plurality of beam settings to steer said directional antenna towards a respective plurality of coverage areas of said transportation route.

31. The system of claim 30, wherein said AP is to switch between said plurality of beam settings according to an order of said coverage areas along said transportation route.

32. The system of claim 26 comprising at least a first AP manager and a second AP manger, said first AP manager to control a first plurality of APs of said plurality of APs, and said second AP manager to control a second plurality of APs of said plurality of APs,
wherein said first plurality of APs cover a first plurality of segments of said transportation route, and said second plurality of APs cover a second plurality of segments of said transportation route.

33. The system of claim 32, wherein said first AP manager is to handover said vehicle from an AP of said first plurality of APs to an AP of said second plurality of APs, when said vehicle moves from a segment of said first plurality of segments to a segment of said second plurality of segments.

34. The system of claim 32, wherein said first AP manager and said second AP manager are to simultaneously provide to said vehicle access to one or more network resources.

35. The system of claim 26, wherein said vehicle includes a train, and said transportation route includes a railroad.

36. The system of claim 26, wherein said directional link comprises a millimeter wave (mmWave) directional link.

37. An access point (AP) manager comprising:
a network interface to interface between said AP manager and a plurality of access points (APs) along a transportation route; and
a controller to control handover of a vehicle moving along said transportation route between said plurality of APs.

38. The AP manager of claim 37, wherein said plurality of APs cover a plurality of segments of said transportation route, and wherein said controller is to handover said vehicle between said plurality of APs according to an order of said plurality of segments along said transportation route.

39. The AP manager of claim 37, wherein said controller is to handover said vehicle from a first AP of said plurality of APs to a second AP of said plurality of APs, based on a quality of communication between said vehicle and at least one AP of said plurality of APs.

40. The AP manager of claim 37, wherein said network interface is to communicate with said plurality of APs via at least one wired link.

41. The AP manager of claim 37, wherein said network interface is to communicate with said plurality of APs via at least one wireless backhaul link.

42. The AP manager of claim 41, wherein said network interface is to communicate with a first AP of said plurality of APs via a wireless backhaul link between said first AP and a second AP of said plurality of APs.

43. A product including one or more tangible computer-readable non-transitory storage media comprising computer-executable instructions operable to, when executed by at least one processor, enable the at least one processor to cause to:
communicate with a vehicle along a transportation route via directional links formed by a plurality of Access Points (APs) along said transportation route; and
control handover of the vehicle between said plurality of APs.

44. The product of claim 43, wherein said plurality of APs cover a plurality of segments of said transportation route, and wherein controlling said handover comprises handing over said vehicle between said plurality of APs according to an order of said plurality of segments along said transportation route.

45. The product of claim 43, wherein the instructions, when executed, cause to hand over said vehicle between said plurality of APs according to a direction of movement of said vehicle along said transportation route.

46. The product of claim 43, wherein the instructions, when executed, cause to switch a directional antenna of an AP of said plurality of APs between a plurality of beam settings to steer said directional antenna towards a respective plurality of coverage areas of said transportation route.

47. The product of claim 43, wherein the instructions, when executed, cause to hand over said vehicle from said plurality of APs to another plurality of APs, when said vehicle moves out from a coverage area of said plurality of APs.

48. A product including one or more tangible computer-readable non-transitory storage media comprising computer-executable instructions operable to, when executed by at least one processor, enable the at least one processor to cause an Access Point (AP) manager to:
communicate between the AP manager and a plurality of APs along a transportation route; and
control handover of a vehicle moving along said transportation route between said plurality of APs.

49. The product of claim 48, wherein said plurality of APs cover a plurality of segments of said transportation route, the instructions, when executed, cause the AP manager to handover said vehicle between said plurality of APs according to an order of said plurality of segments along said transportation route.

50. The product of claim 48, wherein the instructions, when executed, cause the AP manager to handover said vehicle from a first AP of said plurality of APs to a second AP of said plurality of APs, based on a quality of communication between said vehicle and at least one AP of said plurality of APs.
